(19) United States
(12) Patent Application Publication
(10) Pub. No.: US 2011/0121131 A1
(43) Pub. Date: May 26, 2011

(54) Hovering and Flying Vehicle with Shape Memory Alloy Transition Assembly

(75) Inventor: James Elson, Toronto (CA)

(73) Assignee: Spin Master Ltd.

(21) Appl. No.: 12/624,907

(22) Filed: Nov. 24, 2009

(51) Int. Cl. B64C 3/38

(52) U.S. Cl. 244/46

(57) ABSTRACT

The present invention to a flying vehicle having a wing and a shape memory alloy transition assembly partially housed within each side of the wing. The shape memory alloy transition assembly has ends rotatable with respect to each other and separately secured to the wing side in which the end is housed. The shape memory alloy transition assembly has a first position defined as having one wing side oriented at an angle of about 80° to about 180° relative to the other wing side. When the shape memory alloy transition assembly is in the first position the vehicle spins and will fly in a substantially hovering vertical orientation. The shape memory alloy transition assembly has a second position defined as having one wing side is oriented at an angle of about 0° relative to the other wing side. When the shape memory alloy transition assembly is in the second position the vehicle will fly in a substantially horizontal orientation.

### FIELD OF THE INVENTION

The present application relates to remotely controlled flying toy vehicles, and more particularly to remotely controlled toys utilizing shape memory alloy components.

### BACKGROUND OF THE INVENTION

Although toy flying vehicles have been developed for many years, these vehicles typically take the form of either a conventional vehicle such as an airplane or an unconventional vehicle such as a flying saucer or helicopter. One toy which combines the features of a non-conventional flying vehicle with features of a conventional flying vehicle is described in published patent application US 2008/0223994. However, it is important to construct such vehicles using lightweight components so that the vehicle can attain flight while consuming a limited amount of power.

### SUMMARY OF THE INVENTION

The present invention provides a toy flying vehicle which can both hover in the manner of a helicopter or flying saucer and fly in a straight line in the manner of a conventional airplane or flying wing. The present invention further provides a shape memory alloy assembly that allows the present flying toy vehicle to transition between a first position and a second position. In the first position, the vehicle can hover, generating lift from the rotational motion of the body such that the velocity vector of the air flow is non-perpendicular to the major axis of the wing in a plan form view, while in the second position, the vehicle can fly in a substantially straight line such that the lift generated by the wings is the result of an air flow vector that is oriented materially parallel with the flight path. This shape memory alloy transition assembly is lightweight and allows the present toy flying vehicle to attain flight using small standard electric motors equipped with propellers. Furthermore, the shape memory alloy transition assembly of the present invention allows the toy flying vehicle to transition via remote control.

Numerous other advantages and features of the invention will become readily apparent from the detailed description of the invention and the embodiments thereof, from the claims, and from the accompanying drawings.

In at least one embodiment there is provided a flying vehicle having a wing with a first wing side and a second wing side, each of which includes a propeller and a motor for driving the propeller. A power source is provided for providing power to the motor. The flying vehicle also includes a shape memory alloy transition assembly partially housed within each wing side. The transition assembly has ends rotatable with respect to each other and each end is separately secured to the wing side in which the end is housed. The transition assembly has at least a first and a second position.

The first position is defined as having the first wing side oriented in a different direction from the second wing side, such that the first wing side is oriented at an angle of about 80° to about 180° relative to the second wing side. When the first wing side is oriented at an angle of less than 180° relative to the second wing side, the first and second wing sides will be oriented so as to be offset from a substantially horizontal orientation. When the transition assembly is in the first position and the propellers are rotating, the entire vehicle will spin and will fly in a substantially hovering vertical orientation, meaning the vehicle rises off the ground and hovers at a height determined at least in part by the amount of power provided to the propellers.

The second position is defined as having each wing side oriented in a substantially horizontal position and in a substantially similar direction, such that the first wing side is oriented at an angle of about 0° relative to the second wing side. When the transition assembly is in the second position and the propellers are rotating, the vehicle will fly in a substantially horizontal orientation.

In at least one embodiment a flying vehicle is provided, the flying vehicle comprising:
a first wing side and a second wing side, each of the first wing side and the second wing side having a propeller;
at least one motor for driving the propellers;
a power source for providing power to the at least one motor; and
a transition assembly having a first position and a second position, the first position being defined as having the first wing side oriented at an angle of about 80° to about 180° relative to the second wing side, such that when the transition assembly is in the first position and the propellers are rotating, the vehicle spins and will fly in a substantially hovering vertical orientation, and the second position being defined as having the first wing side oriented at an angle of about 0° relative to the second wing side, such that when the transition assembly is in the second position and the propellers are rotating, the vehicle will fly in a substantially horizontal orientation;
the transition assembly further comprising a shape memory alloy latch, wherein when the shape memory alloy latch is released, the transition assembly moves from the first position to the second position.

In at least one embodiment, the transition assembly comprises:
a first rotating end secured to the first wing side;
a second rotating end secured to the second wing side;
a retaining member adapted to releasably retain the first rotating end and the second rotating end in relation to each other so as to maintain the transition assembly in the first position;
a biasing member adapted to bias the first rotating end and the second rotating end in relation to each other so as to bias the transition assembly toward the second position; and
a shape memory alloy latch operatively linked to the retaining member such that when the shape memory alloy latch is operated and the transition assembly is in the first position, the retaining member is released, allowing the transition assembly to rotate from the first position to the second position under the bias of the biasing member.

### BRIEF DESCRIPTION OF THE DRAWINGS

Preferred embodiments of the present invention will now be described in greater detail and will be better understood when read in conjunction with the following drawings in which:

FIG. 1 illustrates a flying toy vehicle according to at least one embodiment of the present invention in a flying position;

FIG. 2 illustrates the embodiment of FIG. 1 in a hovering position;

FIG. 3 shows an exploded view of the embodiment of FIGS. 1 and 2, showing the recess between the wing sides where the transition assembly is located;

FIG. 4 illustrates the embodiment of FIGS. 1 and 2 in various positions transitioning from hovering to flying;

FIG. 5 illustrates the embodiment of FIGS. 1 and 2 in various transition positions showing the various rotational angles between wing sides;

FIG. 6 is an exploded view of a transition assembly according to at least one embodiment of the present invention arranged in the second or flying position;

FIG. 7 is a perspective view of a transition assembly according to at least one embodiment of the present invention;

FIG. 8 is a perspective view of a key plate and lock stop according to at least one embodiment of the present invention;

FIG. 9 is a perspective view of a head cover and a lock stop according to at least one embodiment of the present invention;

FIG. 10 is a perspective view of a cam cover according to at least one embodiment of the present invention;

FIG. 11 is a cross-sectional view of the shape memory alloy latch according to at least one embodiment of the present invention; and

FIG. 12 is an exploded view of the transition assembly according to at least one embodiment of the present invention wherein the key plate has been removed.

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or the embodiments illustrated.

The present invention provides a flying vehicle having a wing with a first and second wing side. In at least one embodiment, each wing side includes a propeller that is powered by a motor. A power source is provided to provide electrical power to the motor. The power source is any device capable of storing electrical energy which is suitable for use in connection with the present application, including but not limited to one or more rechargeable lithium ion polymer batteries, rechargeable nickel cadmium batteries, disposable alkaline batteries or any other suitable type of battery.

The first and second wing sides are connected by way of a transition assembly, which has at least a first position and a second position. The first position orients the first wing side at an angle of about 80° to about 180° relative to the second wing side, such that when propellers are operating the flying vehicle will fly vertically in a hovering orientation. The second position orients the first wing side at an angle of about 0° relative to the second wing side, such that when the propellers are operating the flying vehicle will fly horizontally. In at least one embodiment, the transition assembly can adopt one or more intermediate positions between the first position and the second position, either for a determined period of time or transiently, as the transition assembly is moving between the first and second positions.

The transition assembly is transitioned from the first position to the second position by way of a shape memory alloy latch. In at least one embodiment, the shape memory alloy latch includes a shape memory alloy wire, which is housed in a channel provided in the shape memory alloy latch. The shape memory alloy wire contracts within the channel when power is provided from a power source connected to the shape memory alloy latch.

Shape memory alloys are known in the art and are readily available. A defining characteristic of a shape memory alloy is that it changes shape when heated above its transition temperature. Without being bound by theory, this change in shape is the result of a molecular realignment, the energy for which comes from the heat applied to the alloy. The transition temperature of a shape memory alloy is the temperature at which the alloy changes from the Martensite phase to the Austenite phase. An alloy is heated into its Austenite phase and then formed into a given shape (the “original” shape). The alloy is then cooled and allowed to change into its Martensite phase. At this point, the shape memory alloy can be deformed by, for example, being stretched or bent by some external force. When heated again above its transition temperature, the alloy changes into its Austenite phase, which returns it to its original shape.

The present shape memory alloy wire is constructed of an alloy that returns to its original shape by contracting when heated above its transition temperature, by methods including but not limited to application of an electric current, and then can be stretched or reshaped upon re-cooling, such as once the current is removed. Suitable shape memory alloys include but are not limited to alloys comprising copper, zinc, aluminum and nickel, alloys comprising copper, aluminum and nickel and alloys comprising nickel and titanium.

In at least one embodiment, the transition assembly includes a first rotating end secured to the first wing side and a second rotating end secured to the second wing side. A retaining member is provided that releasably retains the first rotating end relative to the second rotating end such that the transition assembly is releasably retained when in the first position. A biasing member is also provided that biases the first rotating end relative to the second rotating end such that the transition assembly is biased towards the second position.

In at least one embodiment, the shape memory alloy latch is operatively linked to the retaining member such that when power is provided to the shape memory alloy latch, the latch is activated and the retaining member is released. Once the retaining member is released, the first rotating end is free to rotate relative to the second rotating end and the transition assembly is biased to the second position by the biasing member.

In at least one embodiment, the retaining member is a retractable pin and the first rotating end and the second rotating end are adapted to engage the retractable pin when the transition assembly is in the first position. The shape memory alloy latch is operatively linked to the retractable pin, such that when the shape memory alloy latch is operated, the retractable pin is disengaged from one or both of the first and second rotating ends, permitting the first rotating end to rotate relative to the second rotating end. In this way the transition assembly is moved to the second position by the biasing force of the biasing member.

The biasing member can be any suitable member known in the art which is capable of exerting a force, including but not limited to magnetic biasing members, elastic biasing members or spring biasing members, including but not limited to compression springs, torsion springs, cantilever springs, leaf springs, coil springs, polymer springs or other well known springs. In at least one embodiment, the biasing member is a torsion spring that has a first and second end. The first end of the torsion spring is adapted to engage the first rotating end of the transition assembly and the second end of the torsion spring is adapted to engage the second rotating end of the transition assembly. When the transition assembly is in the first position, the torsion spring is deformed so as to rotationally bias the transition assembly towards the second position. When the retaining member is released, the torsion spring is allowed to relax towards its rest position, moving the transition assembly towards the second position.

In at least one embodiment, the first rotating end of the transition assembly can include a key plate having a key that projects from the key plate. The key can take any suitable shape such as a triangle, square, hexagon, eccentric shape or other polygon provided that the key will translate rotational motion to an element having a mating aperture. In at least one embodiment, the key plate can further include a channel that is adapted to receive the retractable pin.

In at least one embodiment, the first rotating end can further include a lock stop that has a key aperture that receives and mates with the key such that the lock stop rotates along with the key plate when the key plate is rotated. In at least one embodiment, the lock stop further includes an aperture adapted to receive the first end of the torsion spring.

In at least one embodiment, the second rotating end of the transition assembly includes a cam cover and a head cover. The cam cover is rotatably mounted between the key plate and the lock stop such that the cam cover is free to rotate relative to the key plate and the lock stop. In at least one embodiment, the cam cover further includes a retractable pin aperture which is adapted to receive the retractable pin when the transition assembly is in the first position. The head cover is adapted to connect with the cam cover and rotate with the cam cover relative to the key plate and lock stop of the first rotating end. In at least one embodiment, the head cover includes an aperture which is adapted to receive the second end of the torsion spring. In at least one embodiment, the head cover also includes a first flange and a second flange. The opening defined between the first flange and second flange is adapted to receive the lock stop of the first rotating end, which can move between the first and second flanges. In at least one embodiment, the lock stop includes a stop which projects radially away from the key aperture, and is positioned to abut either the first flange or the second flange.

In this way, in at least one embodiment, when the transition assembly is moved to a first position, the cam cover and the head cover of the second rotating end rotate relative to the key plate and lock stop of the first rotating end, and the lock stop abuts the first flange of the head cover. Furthermore, when the transition assembly is moved to the first position, the retractable pin is biased to engage the retractable pin aperture provided in the cam cover, which serves to retain the transition assembly in the first position, contrary to the biasing force of the torsion spring, which is adapted to bias the transition assembly towards the second position.

Once the shape memory alloy latch is activated, the retractable pin is disengaged from the retractable pin aperture of the cam cover, which permits the key plate and lock stop of the first rotating end to rotate relative to the head cover and the cam cover of the second rotating end under the biasing force of the torsion spring, until the lock stop abuts the second flange of the head cover and the transition assembly is in the second position.

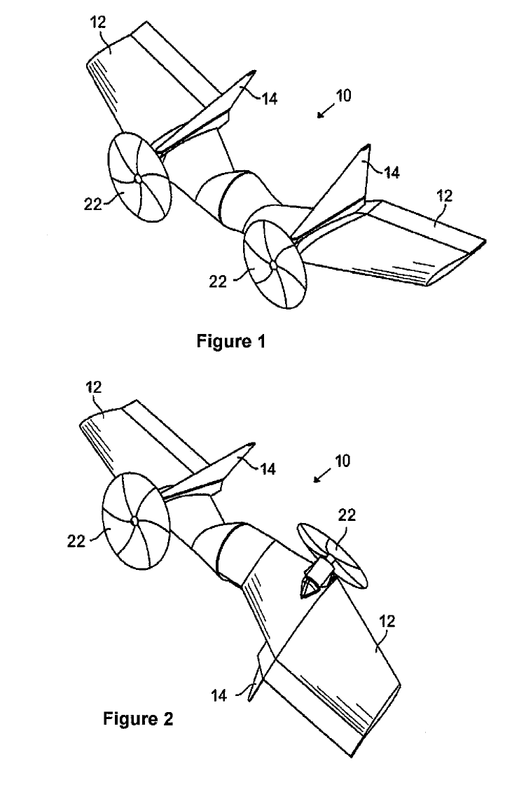

Referring now to FIGS. 1 and 2, at least one embodiment of a vehicle in accordance with present invention is illustrated. In at least one embodiment, vehicle 10 can be remote controlled such that vehicle 10 can transition from a first position (FIG. 2) to a second position (FIG. 1) by depressing a button or switch on a remote control. In this embodiment, the first position corresponds to a hovering position and the second position corresponds to a flying position. It is also contemplated that in at least one embodiment, a button is provided on the remote control which can transition vehicle 10 from the flying position to the hovering position.

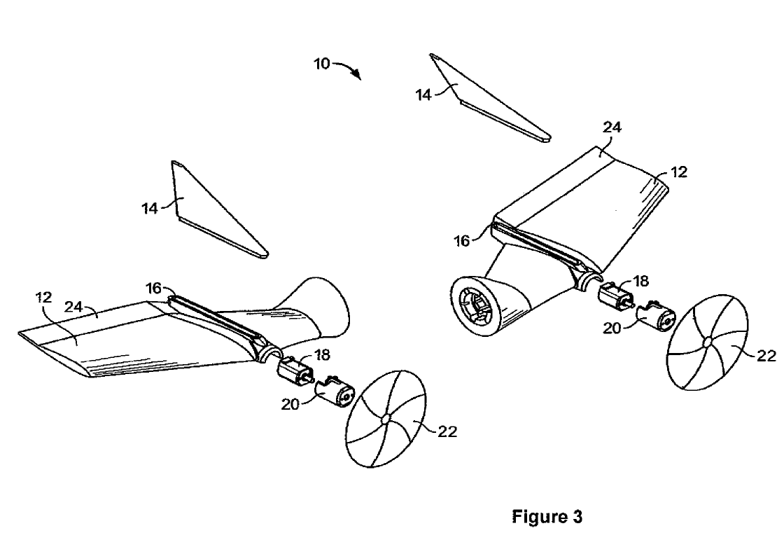

With reference to FIGS. 1, 2 and 3, in at least one embodiment, vehicle 10 is in the form of a flying wing with first and second wing sides 12 that rotatably connect to each other such that the first wing side may rotate with respect to the second wing side. Separate tail sections 14 are secured to a top portion 16 of each wing side 12 to provide direction or longitudinal stability; it will be apparent to the skilled person that such stability can be achieved in many ways, including but not limited to having tail sections molded in one piece with the wing sides and/or attached to different positions of the wing. Each wing side 12 includes a motor 18, motor 18 being housed in a motor cage 20 which is secured to wing side 12. Each motor 18 is powered by a power source (not shown). A propeller 22 is attached to each motor 18.

When assembled, as illustrated in FIGS. 1 and 2, vehicle 10 has a flying position (as seen in FIG. 1) and a hovering position (as seen in FIG. 2). In at least one embodiment, when wing sides 12 are rotated and oriented into the hovering position, the wing sides are approximately 120E out of alignment with each other, however the skilled person in the art will recognize that other angles are possible, including but not limited to angles between 80° and 180°.

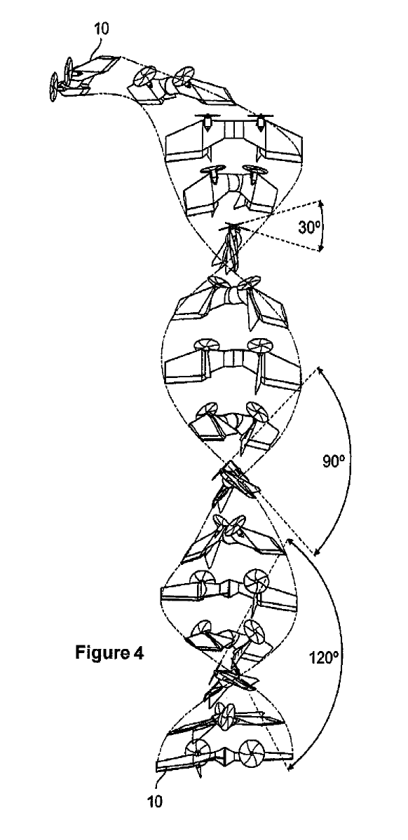

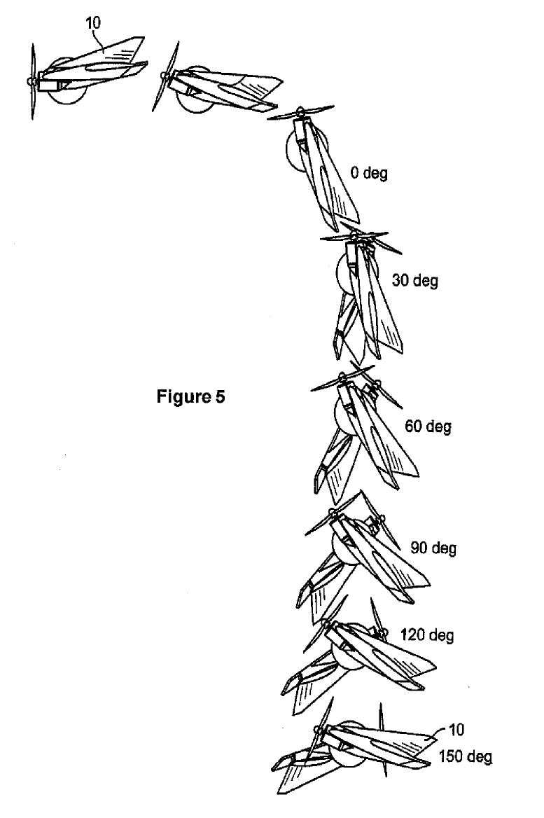

As shown in FIGS. 4 and 5, when in the hovering position, vehicle 10 will spin causing it to lift and hover off the ground. As soon as the user transitions the wing sides into the flying position, the degree of alignment for the wing sides is brought back to 0E, as illustrated in FIGS. 4 and 5. In at least one embodiment this transition may occur in a single rotational motion of the transition assembly or in other embodiments the transition can occur in a series of small incremental movements. In any of such embodiments, vehicle 10 transforms from a hovering position to a flying position and the angle between the wing sides 12 approaches 0E. At the end of the transformation from hovering position to flying position a downward force acting on the top side of the vehicle acts to force the vehicle into a correct flying orientation.

In at least one embodiment, a full tail (including a horizontal and vertical stabilizer) is used to compensate against this downward force and keep the vehicle in the correct flying orientation. Alternatively, in at least one embodiment, vehicle 10 is a flying wing (such as illustrated in FIGS. 1, 2 and 3) and a reflex angle is formed in the trailing edge 24 of wing side 12 to replace the horizontal stabilizer on the tail.

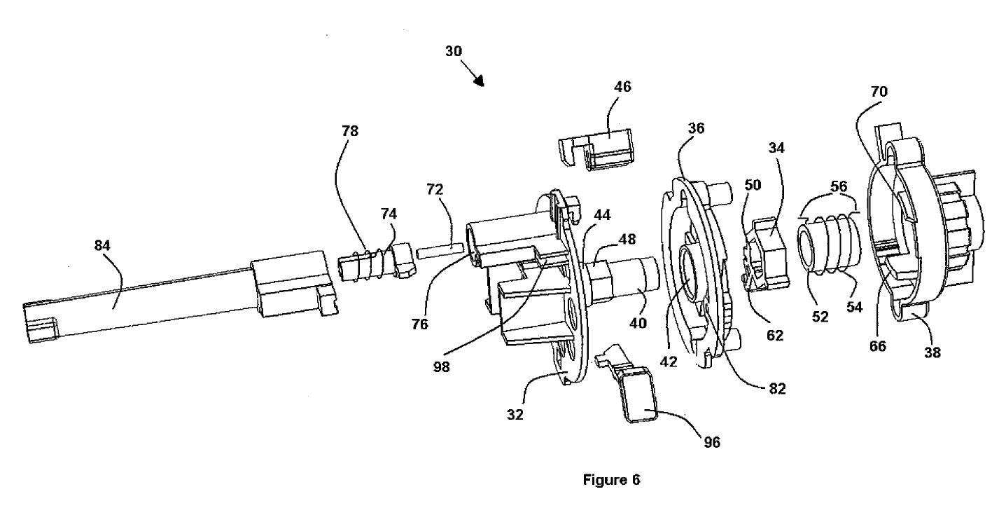

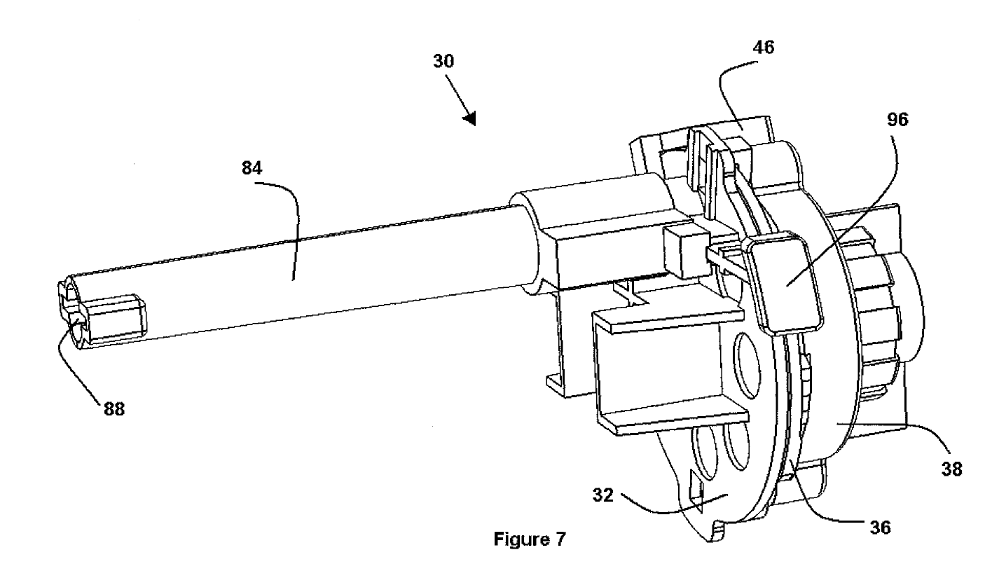

To position wing sides 12 in the hovering position, wing sides 12 must be rotated and oriented into position. To facilitate this, the transition assembly is employed. In at least one embodiment, the transition assembly is a shape memory alloy transition assembly 30, as illustrated in FIGS. 6 and 7, which includes a first rotating end, a second rotating end, a biasing member, a retaining member, and a shape memory alloy latch. In at least one embodiment, shape memory alloy transition assembly 30 further includes a printed circuit board (not shown) which is powered by a power source (also not shown).

With reference to FIG. 6, in at least one embodiment the first rotating end includes a key plate 32 and a lock stop 34 and the second rotating end includes a cam cover 36 and a head cover 38. Cam cover 36 is mounted over key 40 which is provided in the middle of key plate 32, as can be seen in FIG. 6, such that aperture 42 fits over circular shoulder 44 on key 40. This permits cam cover 36 to rotate freely around key 40. Cam cover 36 is aligned with key plate 32 by means of retaining clip 46, which allows key plate 32 and cam cover 36 to rotate relative to each other while remaining mutually aligned.

In at least one embodiment, key 40 of key plate 32 contains a hexagonally shaped projection 48, which mates with hexagonal aperture 50 in lock stop 34, as shown in FIGS. 6 and 8. However, as will be appreciated by the skilled person, projection 48 on key 40 can take any shape provided that key 40 can mate with aperture 50 so as to translate rotational motion to lock stop 34, as described above. Once cam cover 36 is in place over shoulder 44 of key 40, lock stop 34 can be secured onto hexagonal projection 48 on key 40, so as to be rotatably linked with key plate 32. Lock nut 52 is then placed over the key 40.

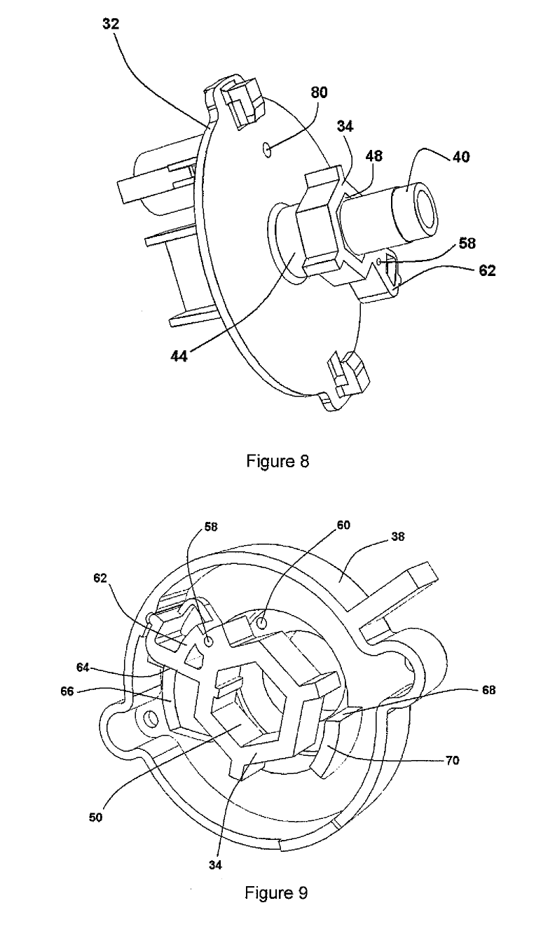

In at least one embodiment the biasing member is a spring 54. Referring again to FIG. 6, in at least one embodiment, spring 54 is in the form of a torsion spring having two ends 56, one of which is inserted into an opening 58 in the lock stop 34 and the other of which is inserted into an opening 60 in the head cover 38 (seen in FIG. 9). Spring 54 is mounted around key 40 and over lock nut 52, as can be seen in the exploded view of FIG. 6. When assembled, as shown in FIG. 7, cam cover 36 is secured to head cover 38 such that the two can rotate together with respect to key plate 32 and lock stop 34, which is secured to key plate 32 as described above. Spring 54 acts to bias the position of cam cover 36 and head cover 38 with respect to key plate 32 and lock stop 34 such that shape memory alloy transition assembly 30 holds the wing sides 12 in the flying position. As can be seen in FIG. 9, the lock stop 34 further includes stop 62, which is positioned against edge 64 of the flange 66 when the vehicle is in the flying position.

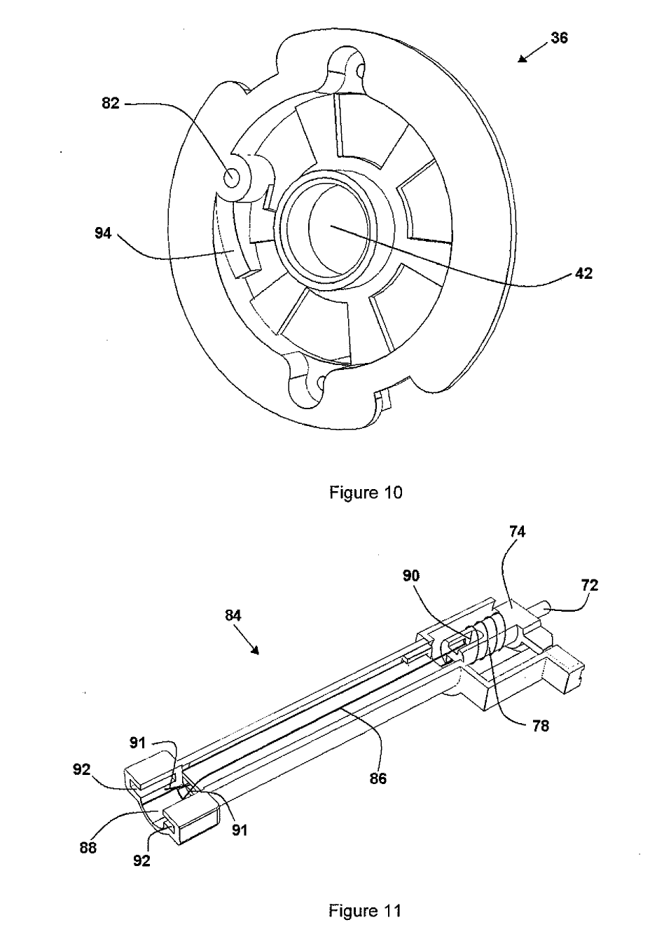

In at least one embodiment, the retaining member is a pin 72. Pin 72 is attached to pin mandrel 74, which is housed in pin-retaining channel 76 on key plate 32, as shown in FIG. 6. Pin 72 is biased towards key plate 32 by a spring 78 such that pin 72 passes through opening 80 (seen in FIG. 8) in key plate 32. When the transition assembly 30 is in the hovering position, pin 72 engages opening 82 (as seen in FIG. 10) on the cam cover 36, so that rotation of key plate 32 and cam cover 36 relative to each other is prevented, thus acting to retain the wing sides 12 in the hovering position.

The shape memory alloy latch 84 is operatively linked to retaining pin 72. As illustrated in FIG. 11, in at least one embodiment, shape memory alloy latch 84 houses a shape memory alloy wire 86 in channel 88. Shape memory alloy wire 86 passes through channel 88, through opening 90 in pin mandrel 74, and back through channel 88, such that both ends 91 of shape memory alloy wire 86 are attached, by soldering or any other suitable method known in the art, to a printed circuit board (not shown) positioned in slots 92 within the mouth of channel 88. A power source (not shown) connected to the printed circuit board attached to ends 91 of shape memory alloy wire 86 provides power to the shape memory alloy latch, and can be arranged within wing side 12 in any manner determined suitable by a skilled person in the art. Application of electric current to the shape memory alloy wire 86 causes the wire 86 to contract, urging pin mandrel 74 and pin 72 to slide within pin retaining channel 76 away from key plate 32 against the biasing force of spring 78, such that pin 72 is retracted.

To move shape memory alloy transition assembly 30 such that it holds the wing sides 12 in the hovering position, cam cover 36 and head cover 38 are rotated with respect to key plate 32 and lock stop 34 such that spring 54 (having one end 56 secured to opening 60 in head cover 38 and one end 56 secured to opening 58 in lock stop 34) is deformed. As head cover 38 is rotated against the biasing force of spring 54, stop 62 of lock stop 34 will eventually engage the edge 68 on the flange 70 provided on head cover 38 (as can be seen in FIG. 9). At the same time, pin 72 is urged along surface 94 to engage opening 82 (as seen in FIG. 10) on the cam cover 36, thus acting to retain the wing sides 12 in the hovering position. When pin 72 is removed from opening 82 on cam cover 36 by the action of shape memory alloy latch 84, the biasing force of spring 54 will induce head cover 38 and cam cover 36 to rotate with respect to key plate 32 and lock stop 34, causing stop 62 of lock stop 34 to move so as to abut edge 64 of flange 66, thereby re-orienting the wing sides 12 into the flying position.

In at least one embodiment, vehicle 10 can be transitioned manually from the flying position to the hovering position by rotating one wing side 12 relative to the other wing side 12 (and against the biasing force of spring 54) until pin 72 positively engages opening 82 on cam cover 36 and locks vehicle 10 in the hovering position.

In at least one embodiment, vehicle 10 is further equipped with a motor that can electrically transition vehicle 10 from the flying position to the hovering position. In this embodiment, a motor is provided which can rotate the shape memory alloy transition assembly against the biasing force of spring 54. The motor can be positioned in any way deemed acceptable by the skilled person in the art provided that the motor can rotate the transition assembly from the flying position to the hovering position. This could be accomplished by means of spur gears located within the wing sides 12 which mate with a drive gear, allowing the wing sides 12 to rotate with respect to one another, among other arrangements that will be readily apparent to the skilled person in the art.

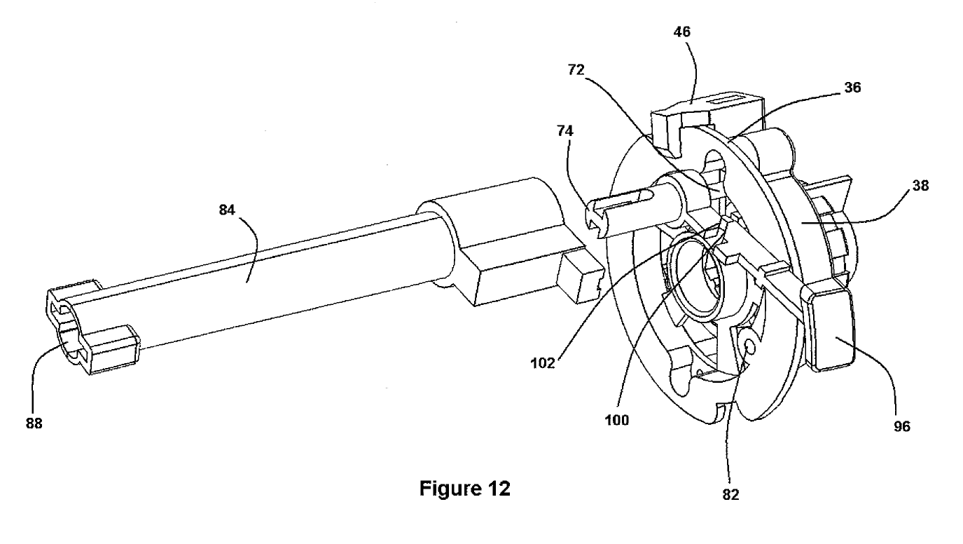

In at least one embodiment, vehicle 10 can be manually transitioned between the hovering position and the flying position. To activate the transition assembly 30 manually, the user can press the release button 96, which is slidably received in a release button channel 98 provided on the key plate 32 (as can be seen in FIG. 6). The release button 96 is biased into a first position. When release button 96 is depressed into a second position, a first wedge surface 100 provided at an opposing end of release button 96 engages a second wedge surface 102 provided on pin mandrel 74, as seen in FIG. 12. When these two wedge surfaces engage, the resultant motion of release button 96 is translated perpendicularly, such that pin mandrel 74 is translated along pin retaining channel 76 provided in key plate 32. Therefore, when pin 72 (which is biased towards the key plate 32 by the action of spring 74) is disengaged from opening 82 in cam cover 36, the spring 54 will rotate head cover 38 into the flying position as described above.

In at least one embodiment, a user can launch vehicle 10 (positioned in the hovering position) from the ground by placing it on a flat surface or a stand, and activating motors 18 using the remote control. Once vehicle 10 has ascended to the desired altitude, the user can initiate the transition sequence, for example, by pressing a transform button on a remote control. When the transition from hovering position to flying position happens the vehicle transforms from spinning with the wing sides 12 oriented approximately 80 to 180 degrees from each other, to flying with the wing sides 12 about 0 degrees from each other.

In at least one embodiment, the tail section may be pointing up or down in the hovering position and in other embodiments no tail at all will be present. The position of the tail (if so included) can be chosen by the skilled person in the art with a readily predictable effect on the overall flight of vehicle 10.

The above-described embodiments of the present invention are meant to be illustrative of preferred embodiments of the present invention and are not intended to limit the scope of the present invention. Various modifications, which would be readily apparent to one skilled in the art, are intended to be within the scope of the present invention. The only limitations to the scope of the present invention are set out in the following appended claims.

We claim:

1. A flying vehicle comprising:
a wing comprising a first wing side and a second wing side, each of the first wing side and the second wing side having a propeller;
at least one motor for driving the propellers;
a power source for providing power to the at least one motor; and
a transition assembly having a first position and a second position,
the first position being defined as having the first wing side oriented at an angle of about 80° to about 180° relative to the second wing side, such that when the transition assembly is in the first position and the propellers are rotating, the vehicle spins and will fly in a substantially hovering vertical orientation,
the second position being defined as having the first wing side oriented at an angle of about 0° relative to the second wing side, such that when the transition assembly is in the second position and the propellers are rotating, the vehicle will fly in a substantially horizontal orientation;
the transition assembly comprising a shape memory alloy latch, wherein when the shape memory alloy latch is released, the transition assembly moves from the first position to the second position.

2. The flying vehicle of claim 1 wherein the shape memory latch comprises a shape memory alloy wire and the power source is connected to the shape memory alloy wire, such that when the power source is activated, the shape memory alloy wire contracts.

3. The flying vehicle of claim 2 wherein the shape memory alloy wire comprises an alloy selected from a copper-zinc-aluminum alloy, a copper-aluminum-nickel alloy and a nickel-titanium alloy.

4. The flying vehicle of claim 1 wherein the power source is a lithium ion polymer battery.

5. The flying vehicle of claim 1 wherein the transition assembly further comprises:
a first rotating end secured to the first wing side;
a second rotating end secured to the second wing side;
a retaining member adapted to releasably retain the first rotating end and the second rotating end in relation to each other so as to maintain the transition assembly in the first position;
a biasing member adapted to bias the first rotating end and the second rotating end in relation to each other so as to bias the transition assembly toward the second position,
wherein the shape memory alloy latch is operatively linked to the retaining member such that when the shape memory alloy latch is operated and the transition assembly is in the first position, the retaining member is released, allowing the transition assembly to rotate from the first position to the second position under the bias of the biasing member.

6. The flying vehicle of claim 5 wherein the retaining member is a retractable pin; at least one of the first rotating end and the second rotating end is adapted to engage the retractable pin when the transition assembly is in the first position so as to retain the transition assembly in the first position against the bias of the biasing member; and the shape memory alloy latch is operatively linked to the retractable pin; such that when the shape memory alloy latch is operated, the retractable pin is retracted from engagement with at least one of the first rotating end and the second rotating end, allowing the first rotating end and the second rotating end to rotate with respect to each other under the bias of the biasing member such that the transition assembly attains the second position.

7. The flying vehicle of claim 6 wherein the biasing member is a torsion spring comprising a first extension end and a second extension end, the torsion spring adapted to engage the first rotating end and the second rotating end.

8. The flying vehicle of claim 7 wherein the first rotating end comprises:
a key plate, the key plate comprising:
a key that projects from the key plate; and
a channel portion adapted to receive the retractable pin; and
a lock stop comprising:
a key aperture adapted to receive and mate with the key of the key plate such that the lock stop is connected to and adapted to co-rotate with the key plate;
a stop that projects radially from the key aperture; and
a first extension end aperture adapted to receive the first extension end of the torsion spring;
and the second rotating end comprises:
a cam cover mounted rotatably between the key plate and the lock stop; the cam cover comprising a retaining pin aperture adapted to receive the retaining pin when the transition assembly is in the first position; and
a head cover connected to and adapted to co-rotate with the cam cover such that the lock stop is between the head cover and the cam cover, the head cover having:
a second extension end aperture adapted to receive the second extension end of the torsion spring; and
a first flange and a second flange defining an opening therebetween for receiving the stop of the lock stop;
such that when the transition assembly is moved to the first position the cam cover and head cover rotate with respect to the key plate, such that the stop of the lock stop abuts the first flange, the torsion spring is deformed, and the retaining pin is biased so as to be received by the retaining pin aperture of the cam cover, and
when the shape memory alloy latch is activated, the retaining pin is disengaged from the retaining pin aperture of the cam cover, such that the torsion spring relaxes, and the cam cover and head cover rotate such that the stop of the lock stop abuts the second flange.

9. The flying vehicle of claim 1 wherein the first position is further defined as having the first wing side and the propeller secured thereto oriented at an angle of about 120E from the other wing side.

10. The flying vehicle of claim 1 wherein the transition assembly further comprises:
a motor mechanism, a gear driven by the motor mechanism in at least a first direction, and a spur gear partially secured within each wing side, each spur gear being meshed to the gear such that the motor mechanism when operating rotates one of the wing sides with respect to the other wing side.

11. The flying vehicle of claim 10 wherein the motor mechanism drives the gear in two directions, such that the transition assembly is mechanically movable from the first position to the second position and from the second position to the first position.

12. The flying vehicle of claim 1 wherein each wing side includes a trailing edge, the trailing edge further defining a reflex angle.

13. The flying vehicle of claim 1, further comprising a rearwardly projecting tail section, the tail section being positioned between the pair of wing sides, the tail section having at least one vertical stabilizer and at least one horizontal stabilizer.

14. The flying vehicle of claim 8, further comprising a manual release button operable to disengage the retaining pin from the aperture in the cam cover, whereby the spring causes the cam cover and head cover to rotate such that the transition assembly is moved to the second position.

15. The flying vehicle of claim 8, further comprising a locknut mounted on the key between the lock stop and the head cover, wherein the coil section of the spring is positioned coaxially around the locknut.

16. The flying vehicle of claim 8 wherein the key is hexagonally shaped.
